(19) United States
(12) Patent Application Publication
(10) Pub. No.: US 2026/0180436 A1
(43) Pub. Date: Jun. 25, 2026

(54) SWITCHED-MODE POWER SUPPLY

(71) Applicant: LOGICDATA Electronic & Software Entwicklungs GmbH, Deutschlandsberg (AT)

(72) Inventor: Mario Schenk, Deutschlandsberg (AT)

(21) Appl. No.: 19/421,281

(22) Filed: Dec. 16, 2025

(30) Foreign Application Priority Data
Dec. 20, 2024 (DE) 10 2024 139 140.5

(51) Int. Cl. H02M 1/36; H02M 1/00; H02M 1/14; H02M 7/217

(52) U.S. Cl. CPC H02M 1/36; H02M 1/007; H02M 1/14; H02M 7/217

(57) ABSTRACT

A switched-mode power supply with a standby and a normal operating state includes a transformer with a primary side and a secondary side. A circuit arrangement on the primary side is coupled to the primary side of the transformer and comprises a start-up circuit. The start-up circuit includes a first buffer store, a first resistive element and a switch and is configured to generate the supply voltage for a switching regulator module in the standby operating state. A circuit arrangement on the secondary side is coupled to the secondary side of the transformer and is configured to provide at least one output voltage smoothed and buffered via a second buffer store. A coupling component with a signal path for a switching signal from the circuit arrangement on the secondary side to the primary side includes a first and a second side which are galvanically decoupled from one another.

### REFERENCE TO RELATED APPLICATIONS

This Application claims priority to German Application number 10 2024 139 140.5, filed on Dec. 20, 2024. The contents of the above-referenced Patent Applications are hereby incorporated by reference in their entirety.

### FIELD

The disclosure relates to a switched-mode power supply with a standby operating state and a normal operating state.

### BACKGROUND

In the context of energy efficiency standards, a minimum average efficiency of external power supplies during operation and a maximum current consumption during no-load operation are prescribed. For example, a burst or pulse skipping mode can help to reduce no-load losses by only switching on the power supply when it is necessary to maintain the output voltage in order to stay within specification. Often the power supply is either switched off or in a standby operating state (standby mode).

A switched-mode power supply of this type, used in particular in an electrically adjustable furniture system, which is operated in so-called burst mode to reduce the power in the standby operating state, is known from EP 2366216 B1. In this burst mode, the power supply unit is switched on cyclically within a comparatively short switch-on phase and then remains in the disabled state within a comparatively long switch-off phase. The longer the switch-off phase is compared to the switch-on phase, the lower the switching losses and thus the power in the standby operating state.

The circuit used for the time span of the switch-on phase usually consists of an RC element whose time constant is determined by the size of a resistor R. If the resistor is small, the switch-on phase is shorter. If the resistor is small, the switch-on phase is short, but the power consumption is high and the average consumption in the standby operating state increases. A large resistance leads to an undesirably long start-up time for the switched-mode power supply.

### SUMMARY

The present disclosure provides an improved switching concept for a switched-mode power supply in order to reduce the power consumption in the standby operating state.

Further findings of the present disclosure consist in creating a circuit-technically simple activation of the normal operating state by pressing a manual switch or by an activation signal from a microcontroller, with simultaneous galvanic isolation of the manual switch or the microcontroller from the mains voltage or primary-side voltage of a switched-mode power supply.

One embodiment of a switched-mode power supply according to the improved switching concept with a standby operating state and a normal operating state, e.g. for an electrically adjustable furniture system, comprises a transformer with a primary side and a secondary side, wherein the transformer comprises a primary coil, a secondary coil and an auxiliary coil, is supplied with a rectified voltage in cycles on the primary side and is used to supply a load on the secondary side.

The improved switching concept is based on the idea that in the standby operating state, a switch connected to the transformer on the primary side is activated during a short switch-on phase of a burst cycle compared to a switch-off phase.

The switched-mode power supply further comprises a primary-side circuit arrangement, a secondary-side circuit arrangement and a coupling component with a signal path for a secondary-side switching signal from the secondary-side circuit arrangement to the primary-side circuit arrangement. The coupling component comprises a first side and a second side, which are galvanically decoupled from each other.

The primary-side circuit arrangement is coupled to the primary side of the transformer and comprises a power stage for clocking the transformer and a start-up circuit, whereby the start-up circuit comprises a first buffer store, a first resistive element and a switch and is configured to generate the supply voltage for a switching regulator module in the standby operating state.

The secondary-side circuit arrangement is coupled to the secondary side of the transformer and is configured to provide at least one output voltage smoothed and buffered via a second buffer store. The secondary-side circuit arrangement is configured to supply the coupling component with a current from the second buffer store. The primary-side circuit arrangement also includes a switch controller for charging the first buffer store. The switch controller is configured to periodically open and close the state of the switch in the standby operating state.

Among other things, this makes it possible to keep the resistance of an RC element low and thus keep the switch-on phase short while still reducing the power consumption in the standby operating state.

In various embodiments, the switching signal occurring in the secondary-side circuit arrangement in the standby operating state acts on the primary-side circuit arrangement via the signal path in such a way that
the switch of the start-up circuit is electrically conductive by means of the switch controller;
the supply voltage of the switching regulator module reaches an upper threshold value;
the switching regulator module outputs at least one clock signal to clock the transformer; and
sufficient energy is transferred to the first buffer store via the primary coil and the auxiliary coil to supply voltage to the switching regulator module.

This is achieved, for example, by clocking the transformer, in particular the primary side of the transformer or the primary coil.

For example, the switch controller has a third buffer store, which is charged with energy from the auxiliary coil via a second resistive element and a diode.

The first buffer store and the first resistive element can be dimensioned in such a way that in the standby operating state, a period of time for charging the first buffer store is greater than a period of time for discharging the first buffer store by the switching regulator module, whereby the period of time for charging the first buffer store is less than 300 ms.

In various embodiments, the first resistive element is less than 100 kΩ or it is realized by a current source.

In various embodiments, the coupling component is configured to set the magnitude of a discharge current for discharging the third buffer store.

The coupling component is set up, for example, to connect a first discharge resistor and a second discharge resistor in parallel. Alternatively, the coupling component is configured to connect a first discharge resistor and a current source or current sink in parallel. In this case, the coupling component itself can represent the current source or current sink.

In various embodiments, the switching frequency of the switch in the standby operating state is dependent on a time constant of an RC element, which is formed from the third buffer store and the first discharge resistor. The time constant of the RC element from the third buffer store and the first discharge resistor is, for example, greater than 10 s and less than 100 s.

In various embodiments, the coupling component comprises a first primary-side contact, a second primary-side contact, a first secondary-side contact and a second secondary-side contact.

For example, the output voltage buffered by the second buffer store is fed to the first secondary-side contact of the coupling component. Alternatively, at least one operating element of a secondary-side manual switch connects the second secondary-side contact of the coupling component to ground. In a further alternative, at least one output of a secondary-side microcontroller connects the second secondary-side contact of the coupling component to ground.

In various embodiments, the coupling component is formed by an optocoupler or a relay.

In various embodiments, the switch of the start-up circuit closes when the coupling component is connected to the output voltage and ground via its secondary-side contacts.

For example, the switch controller comprises an N-channel depletion MOSFET.

### BRIEF DESCRIPTION OF THE DRAWINGS

In the following, the improved switching concept is explained in more detail with various embodiment examples using drawings. These show, partly simplified:

FIG. 1 a block diagram of a conventional switched-mode power supply;

FIG. 2 a simplified circuit diagram of the switched-mode power supply;

FIG. 3 a section with a start-up circuit;

FIG. 4 a section showing a transformer with a primary-side and a secondary-side circuit arrangement;

FIG. 5 a section with a switch controller; and

FIG. 6 a section with a coupling element.

### DETAILED DESCRIPTION

### Components of a Switched-Mode Power Supply

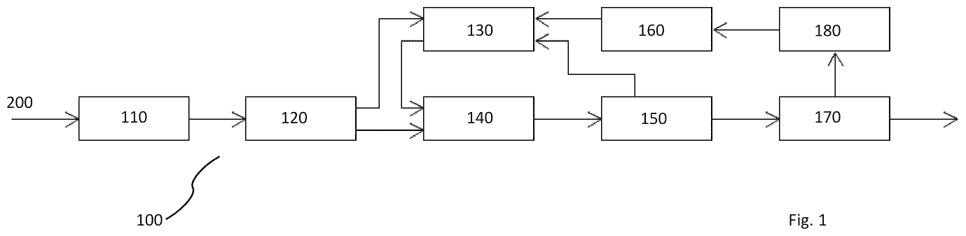

Various types of switched-mode power supply units are known. FIG. 1 shows a representative block diagram of a conventional switched-mode power supply 100. The design of a switched-mode power supply 100 depends on the required power, energy efficiency and quality (mains current deformation, stability of the output voltage, etc.). Smaller switched-mode power supplies (up to around 250 watts) are usually built according to the flyback converter principle and can be found in almost all household appliances. A standard flyback converter power supply usually comprises the following eight components, which are shown in FIG. 1:

Mains input & mains filter 110: Directly after the mains input 200 with e.g. 230V mains voltage, there are usually several protective devices (fuse, NTC, varistor) as well as mains filters (current-compensated choke, X and Y capacitors). A switched-mode power supply causes conducted interference during operation. To compensate for this interference, a mains filter circuit must be installed. Mains filters usually consist of passive components such as coils and capacitors.

Rectification and smoothing 120: In this stage, the AC voltage is rectified and smoothed using diodes. After rectification, the usual effective voltage of 230 volts, for example, is no longer present, but almost the full peak voltage of around 325 volts is present as a DC voltage as the DC link voltage. For example, the AC voltage from mains input 200 is rectified via four diodes. An electrolytic capacitor downstream of the rectifier smoothes and buffers the voltage.

Controller 130: Control usually is done via a switching controller module in the form of an integrated circuit, which in many cases is a simple pulse width modulation, PWM, controller. This controller is also referred to as a “mains IC”, PWC or switching controller module. The task of the switching controller module is to take over control of the PWM from the power transistor. The switching controller module receives the information on how the PWM ratio and therefore the level of the output voltage on the secondary side must be via a potential isolator (e.g. optocoupler). In addition, switching regulator modules usually also have overload protection, which switches off the power supply unit above a certain current flow.

Power stage 140: The power switches of a power supply unit are referred to as the power stage. This is a MOSFET, IGBT or bipolar transistor that switches the primary coil of a transformer several thousand times per second.

Transformer 150: The transformer or transformer consists of several windings and transfers the energy from the primary side to the secondary side. In addition, there is usually at least one third auxiliary winding, which provides the power supply for the control unit 130. Depending on the PWM duty cycle, as much energy is always transferred from the primary side to the secondary side as is ultimately required at the output. The transformer also provides electrical isolation between the primary and secondary sides.

Potential isolator 160: A feedback signal, which is transmitted electrically isolated from the secondary to the primary side by the potential isolator 160, e.g. an optocoupler, informs the control unit 130 whether the output voltage is high enough.

Rectifier 170: A half-wave rectifier circuit, which often consists of a double diode, is located directly on the secondary winding. Subsequently, several electrolytic capacitors connected in parallel are connected to the rectifier to smooth the output voltage.

Regulation 180: Parallel to the load output there is a further circuit which, when a certain voltage is exceeded, informs the control unit 130 via the potential isolator 160 that there is sufficient voltage on the secondary side and that no further boosting is required.

The switching regulator module of the control unit 130 controls the power stage 140 by means of PWM. Only then is the energy transferred from the primary side to the secondary side by the transformer 150. However, before this process can take place, the control unit 130 must already be supplied with energy. For the power supply, the control unit 130 is usually connected to a rectified voltage by means of a starting circuit. This may be derived from the rectifier 170, for example, or from the mains voltage. The start-up circuit comprises a resistor and a buffer. The resistor has a high resistance and supplies only a low current, most of which initially flows into a buffer store. Only when this buffer store is charged is there enough energy left for the control unit to start.

The start time of the switched-mode power supply 100 depends on the size of the resistor and the buffer store. As the start time cannot be arbitrarily long, neither the buffer store nor the resistor should be too large.

As soon as sufficient energy is available, the controller 130 starts to output PWM signals and switch the power stage 140 so that the primary coil of the transformer 150 builds up a magnetic field. This generates a voltage in the secondary coil and an auxiliary coil of the transformer 150. Via the auxiliary coil and an operating supply circuit, the control unit 130 is then permanently supplied with a constant voltage, which is in particular more permanent than via the starting circuit described above.

Subsequently, the switched-mode power supply 100 now starts to ramp up the voltage on the secondary side of the transformer 150. This is followed, for example, by rectification and filtering on the secondary side.

The output voltage of the switched-mode power supply 100 should be kept as constant as possible, e.g. at 12 V. If a larger load is connected, the output voltage drops and the control unit 130 must re-adjust accordingly. The control unit 130 receives this feedback from the secondary side, electrically isolated via the potential isolator 160. A circuit on the secondary side switches on the potential isolator 160 when the correct output voltage is reached. On the primary side, the controller 130 must maintain the PWM on/off ratio according to the feedback or adjust it if necessary. The ratio between switching on and off is referred to as the PWM duty cycle. The percentage of the PWM duty cycle always refers to the switched-on state. This means that power level 140 remains switched on for either slightly longer or shorter. As a result, the primary coil transfers either more or less energy to the secondary coils.

### Conventional Switched-Mode Power Supply with Standby Operating State

In the normal operating state, the switched-mode power supply provides a supply voltage. In the standby operating state, only a voltage with low load capacity or no voltage at all is output by the switched-mode power supply unit. In this case, the switched-mode power supply is configured to provide a supply voltage for the control unit 130 in the standby operating state in a clocked manner by a start-up circuit (part of the control unit 130) and in the normal operating state in a continuous manner by the operating supply circuit. In the standby operating state, the operating supply circuit is disconnected from the control unit.

Thus, in the standby operating state, the control unit 130 and the switching operations triggered by it are periodically switched off in the power stage 140, so that the occurrence of power loss due to unnecessary switching operations is minimized when the output voltage is not required. However, due to the clocked supply of the control unit 130, the switched-mode power supply is in a state that enables a rapid change to the normal operating state, in which corresponding power is provided at the output of the switched-mode power supply.

The start-up circuit is configured to derive the supply voltage for the control unit 130 from a rectified voltage.

For this purpose, the start-up circuit has an energy storage device and a resistive element. The energy storage device and the resistance element are dimensioned in such a way that in the standby operating state, a period of time for charging the energy storage device is greater than a period of time for discharging the energy storage device by the control unit 130. In other words, in the standby operating state, the control unit 130 is supplied with voltage via the energy storage device. This is charged via the resistance element, which is preferably selected to be high-resistance (MΩ range), whereby a certain charging current results from a resistance value of the resistance element. As soon as the charging voltage at the energy storage device exceeds an upper voltage threshold of the switching regulator module in the control unit 130, the switching regulator module begins to output pulses with a specific frequency for the burst duration. The switching regulator module starts pulsing when an upper voltage threshold is reached and stops pulsing when a lower voltage threshold is reached. The current required during the output of the pulses or the initialization of the controller 130 and drawn from the energy store is higher than the charging current, so that the energy store is discharged faster than it is charged by the resistance element. The charging and discharging of the energy store results in clocked operation of the control unit 130. The charging time to reach the upper voltage threshold is significantly longer than the discharging time to fall below the lower voltage threshold of the switching regulator module.

### Description of the Improvements Resulting From the Improved Switching Concept

The start-up circuit used during the standby operating state essentially determines the power consumption during the standby operating state.

The current consumption can be reduced by selecting a high-impedance resistor. However, the resistor cannot be made arbitrarily high-resistance, as otherwise the time for restarting the switching regulator module increases due to the increasing charging time until the upper voltage threshold of the switching regulator module is reached.

According to the improved switching concept, the aim is now to minimize both the power consumption in the standby operating state and the restart time when the normal operating state is activated.

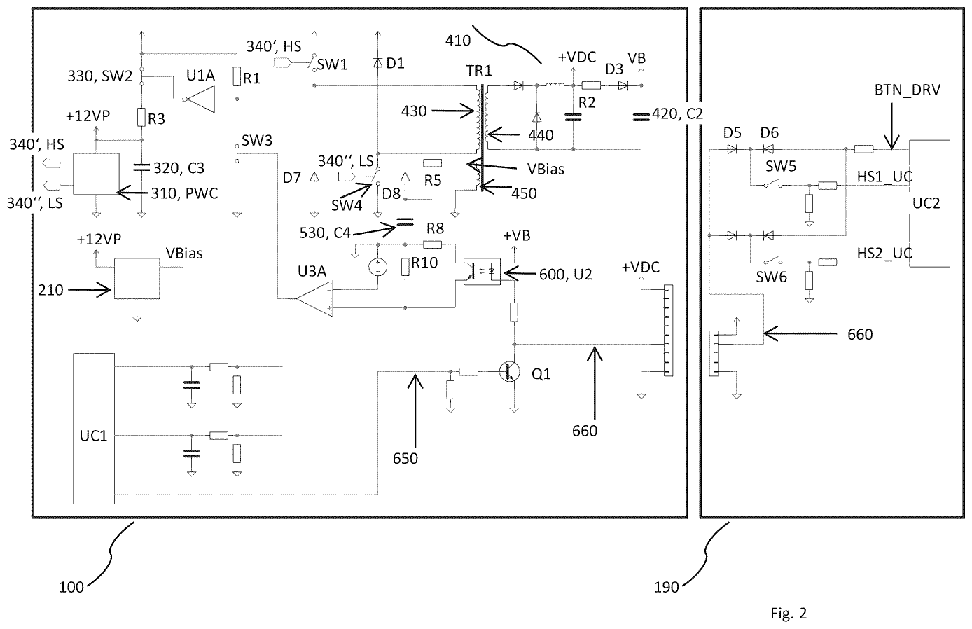

In order to achieve this goal, with reference to FIG. 2, the previously usual high-resistance resistor in the start-up circuit is replaced by a series connection of a low-resistance resistor R3 and a switch 330, SW2, whereby the switch 330, SW2 is switched cyclically, whereby a buffer store 530, C4 is charged with energy from the auxiliary coil 450 of the transformer 150, TR1 and the discharge time of the buffer store 530, C4 determines the time span between switching off and switching on the switch 330, SW2 of the start-up circuit 300.

The time period for charging the first buffer store 320, C3 is less than 300 ms, for example. The resistance element R3 is less than 100 kΩ, for example. As a result, a furniture system reacts sufficiently quickly to the pressing of a button by a user, without the user getting the feeling that the furniture system is defective or malfunctioning.

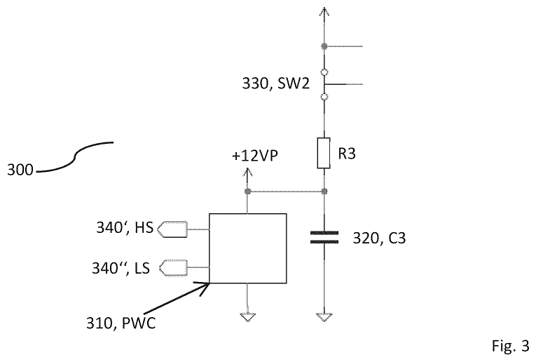

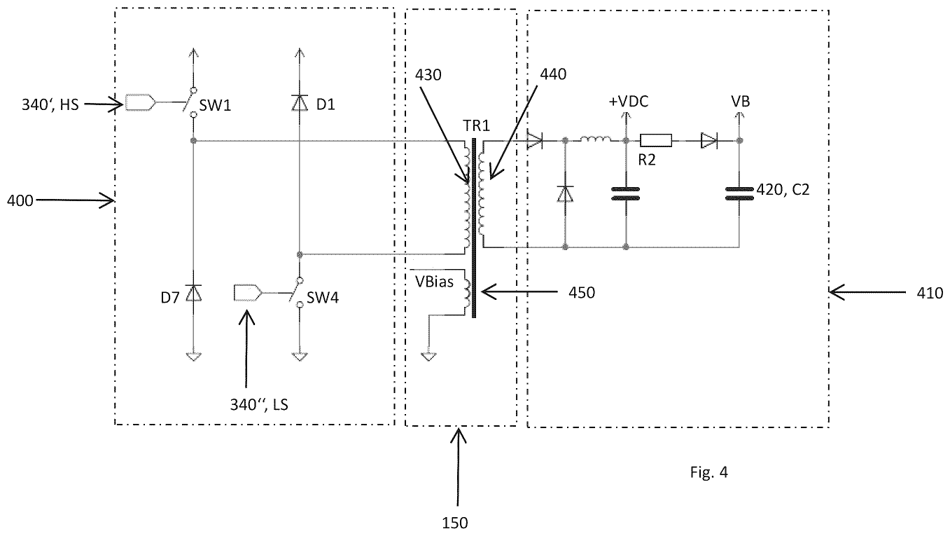

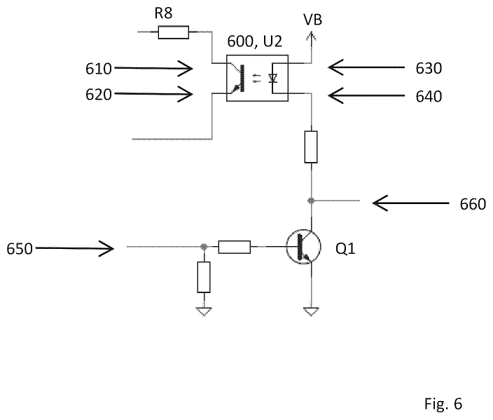

The description of the switched-mode power supply according to the improved switching concept is based on the circuit diagram in FIG. 2 and the sections in FIGS. 2, 3, 4, 5 and 6.

The circuit diagram shows a switching regulator module 310, PWC with, for example, two signal outputs 340′, 340″, HS, LS, for controlling switches SW1 and SW4 of a power stage 140. The power stage 140 also comprises two freewheeling diodes D1 and D7.

The circuit diagram also shows a transformer 150, TR1, in particular a transformer with a primary coil 430, a secondary coil 440 and an auxiliary coil 450.

The auxiliary coil 450 can, for example, be mounted on the primary side.

The switching regulator module 310, PWC is supplied on the one hand by a starting circuit 300 and on the other hand by an operating supply circuit 210, which generates, for example, a 12 V voltage from the energy of the auxiliary coil 450.

The start-up circuit 300 comprises a first buffer store 320, C3, a resistor R3 and a switch 330, SW2. The first buffer store 320, C3 is charged when the switch 330, SW2 is closed.

The operating supply circuit 210 derives an operating voltage 12VP for the switching regulator module 310, PWC from the voltage VBias of the auxiliary coil 450.

An output stage 410 is connected to the secondary coil 440 of the transformer 150, TR1, which provides the output voltage VB to a second buffer store 420, C2.

The circuit diagram also includes a switch controller 500 for the switch 330, SW2. This comprises at least a third buffer store 530, C4, a rectifier comprising the resistor R5 and the diode D8, and a first discharge resistor R10.

### Realization of a Burst Mode in the Standby Operating State

The switch 330, SW2 is switched on after a mains voltage is applied and charges the first buffer store 320, C3. As soon as the voltage of the first buffer store reaches the upper voltage threshold of the switching regulator module 310, PWC, the switching regulator module 310, PWC begins to control the two switches SW1 and SW4 by means of at least one clock signal 340′, 340″, LS, HS with a PWM signal. A voltage is thus induced in the transformer 150, TR1 at the auxiliary coil 450 and the secondary coil 440.

A rectified and smoothed output voltage VB is generated from the voltage at the secondary coil 440.

A further voltage VBias is generated from the voltage at the auxiliary coil 450, which, among other things, feeds the operating supply circuit 410.

The voltage at the auxiliary coil 450 is also used to generate the voltage −VBias, which decreases with each pulse at the transformer 150, TR1. As soon as the voltage −VBias at the third buffer store 530, C4 falls below a threshold value, the switch 330, SW2 is opened. Now no more current flows through R3 and therefore the switching regulator module 310, PWC can only output clock signals 340′, 340″, HS and LS as long as the voltage at the first buffer store 320, C3 is greater than the lower voltage threshold of the switching regulator module 310, PWC. Over time, the third buffer store 530, C4 discharges via the first discharging resistor R10. As soon as the voltage −VBias at the third buffer store 530, C4 exceeds a threshold value, the switch 330, SW2 is closed again and the first buffer store 320, C3 begins to charge again. The switching frequency of the switch 330, SW2 is thus dependent on the time constant of the RC element, which is formed by the third buffer store 530, C4 and the first discharge resistor R10.

The time constant of the RC element lies, for example, in a range from 10 s to 100 s.

This repeats the process described above.

The use of the switch 330, SW2 and the preferably low-ohmic resistor R3 has the advantage over conventional approaches that no current flows in the standby operating state when the switch 330, SW2 is open, and a large charging current flows for a short time when the switch 330, SW2 is closed. This means that the start-up time is very short, while power consumption is minimized in the standby operating state.

### Realizing the Activation of the Standby Operating State

The standby operating state is achieved in a similar way to conventional switched-mode power supply units when the load at the output is reduced. In this case, a feedback loop shown in FIG. 1 informs the switching regulator module 310, PWC in the start-up circuit 300 of the controller 130 via the potential isolator 160 that the output voltage VDC has been reached. The switching regulator module 310, PWC will then reduce the duty cycle of the PWM signals to such an extent that not enough voltage is induced via the auxiliary coil 450 to maintain the operating supply voltage 12VP via the operating supply circuit 410. This causes the switching regulator module 310, PWC to switch to the standby operating state after the first buffer store 320, C3 has been discharged.

### Realization of the Activation of the Normal Operating State

Further findings of the present disclosure consist in achieving activation of the normal operating state via a secondary-side signal transmitter, for example a manual switch 190 or a microcontroller UC1.

For this purpose, the switched-mode power supply 100 may comprise a coupling component 600, U2, which is connected to a second discharge resistor R8. The coupling component 600, U2 can be realized, for example, by an optocoupler or a relay, and is used for galvanic decoupling of the secondary-side signal generator with the input-side switch controller 500.

The coupling component 600, U2 is configured to adjust the size of a discharge current for discharging the third buffer store 530, C4. By activating the coupling component, for example by activating the coupling component 600, U2 by a switching signal via the line 650 from a microcontroller, or by a switching signal via the line 660 from a manual switch, an additional discharge current for discharging the third buffer store 530, C4 is activated, for example by activating an additional second discharge resistor R8 connected in parallel with the first discharge resistor R10. In another embodiment, a current source or current sink can be activated in order to cause an additional discharge current.

The coupling component 600, U2 is fed on the secondary side with the voltage VB from the second buffer store 420, C2. Advantageously, the second buffer store 420, C2 can be simply charged via the charging resistor R2 from a secondary voltage VDC.

In one embodiment, a capacitor with very low self-discharge is used as the second buffer store 420, C2.

The capacitor should provide energy at least until the second buffer store 420, C4 has been sufficiently discharged by switching the coupling component 600, U2 so that the switch 330, SW2 becomes electrically conductive.

The energy stored in the second buffer store 420, C2 can be used by actuating any operating element SW5, SW6 in the manual switch 190 to switch on the switch 330, SW2 of the start-up circuit 300 and to charge the first buffer store 320, C3 within a very short time due to the low-impedance resistor R3.

If the contact 640 of the coupling component 600, U2 is pulled to ground, then the coupling component 600, U2 switches the second discharge resistor R8 in parallel with the first discharge resistor R10, which is why the voltage at the third buffer store 530, C4 discharges more quickly. As soon as a certain negative voltage threshold is exceeded, the switch 330, SW2 is closed and the start-up circuit 300 starts charging the first buffer store 320, C3.

For example, a microcontroller UC1 can pull the contact 640 to ground via a transistor circuit Q1.

For example, actuation of any control element SW5, SW6 in the manual switch 190 may close a connection to ground.

For example, the handswitch 190 may include a microcontroller UC2, e.g., for display and/or function control of one or more operating elements. By using two diodes per switch (for example D5, D6 for SW5 in FIG. 2), it is ensured that even if the microcontroller UC2 is not supplied with voltage, only the closing of the switch SW5 pulls the contact 640 of the coupling component 600, U2 to ground.

The connections BTN_DRV, HS1_uC and HS2_uC shown are used by the microcontroller UC2 of the manual switch 190 to check the function of the respective switch SW5, SW6. For this purpose, BTN_DRV is set to a defined level and reads back via the inputs HS1_uC and HS2_uC whether the respective switch is open or closed.

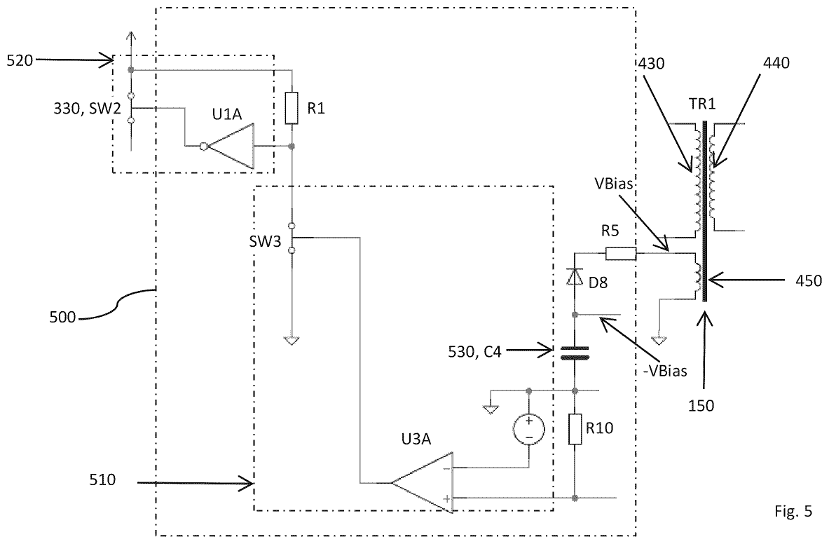

The equivalent circuit diagram of the switch controller shown in FIG. 5 with the comparator U3A, the switch SW3, resistor R1, switch SW2 and inverter U1A can be realized, for example, with an N-channel depletion MOSFET 510 and a PNP transistor 520.

What is claimed is:

1. A switched-mode power supply for an electrically adjustable furniture system, with a standby operating state and a normal operating state, comprising
a transformer with a primary side and a secondary side, wherein the transformer comprises a primary coil, a secondary coil and an auxiliary coil, which is supplied with a rectified voltage on the primary side in a clocked manner and serves to supply a load on the secondary side;
a primary-side circuit arrangement that is coupled to the primary side of the transformer and comprises a power stage for clocking the transformer and a start-up circuit, wherein the start-up circuit comprises a first buffer store, a first resistive element, and a switch, and is configured to generate a supply voltage for a switching regulator module in the standby operating state;
a secondary-side circuit arrangement coupled to the secondary side of the transformer and arranged to provide at least one output voltage smoothed and buffered via a second buffer store; and
a coupling component with a signal path for a secondary-side switching signal from the secondary-side circuit arrangement to the primary-side circuit arrangement, wherein the coupling component comprises a first side and a second side that are galvanically decoupled from each other;
wherein
the secondary-side circuit arrangement is configured to supply the coupling component with a current from the second buffer store;
the primary-side circuit arrangement further comprises a switch controller for charging the first buffer store;
the switch controller has a third buffer store which is configured to be charged with energy from the auxiliary coil via a second resistive element and a diode
the switch controller is configured to periodically open and close a state of the switch in the standby operating state; and
a discharge current of the third buffer store determines a time span between opening and closing the switch.

2. The switched-mode power supply according to claim 1, wherein the first resistive element and the switch are connected in series such that no current flows through the first resistive element when the switch is open.

3. The switched-mode power supply according to claim 1, wherein the secondary-side switching signal occurring in the secondary-side circuit arrangement in an idle operating state acts on the primary-side circuit arrangement via the signal path such that
the switch of the start-up circuit is made electrically conductive by means of the switch controller;
the supply voltage of the switching regulator module reaches an upper threshold value;
the switching regulator module outputs at least one clock signal to clock the transformer; and
via the primary coil and the auxiliary coil sufficient energy is transferred to the first buffer store to supply voltage to the switching regulator module.

4. The switched-mode power supply according to claim 1, wherein the first buffer store and the first resistive element are dimensioned such that, in the standby operating state, a time period for charging the first buffer store is longer than a time period for discharging the first buffer store by the switching regulator module, wherein the time period for charging the first buffer store is less than 300 ms.

5. The switched-mode power supply according to claim 1, wherein the first resistive element is less than 100 kΩ or the first resistive element is implemented by a current source.

6. The switched-mode power supply according to claim 1, wherein the coupling component is configured to adjust a magnitude of the discharge current for discharging the third buffer store.

7. The switched-mode power supply according to claim 6, wherein the coupling component is configured to connect a first discharge resistor and a second discharge resistor in parallel.

8. The switched-mode power supply according to claim 6, wherein the coupling component is configured to connect a first discharge resistor and a current source or current sink in parallel.

9. The switched-mode power supply according to claim 8, wherein the coupling component itself represents the current source or current sink.

10. The switched-mode power supply according to claim 7, wherein a switching frequency of the switch in the standby operating state depends on a time constant of an RC element formed by the third buffer store and the first discharge resistor.

11. The switched-mode power supply according to claim 10, wherein the time constant of the RC element formed by the third buffer store and the first discharge resistor is greater than 10 s and less than 100 s.

12. The switched-mode power supply according to claim 1, wherein the coupling component comprises a first primary-side contact, a second primary-side contact, a first secondary-side contact, and a second secondary-side contact.

13. The switched-mode power supply according to claim 12, wherein the output voltage buffered by the second buffer store is fed to the first secondary-side contact of the coupling component.

14. The switched-mode power supply according to claim 12, wherein at least one control element of a secondary-side manual switch connects the second secondary-side contact of the coupling component to ground.

15. The switched-mode power supply according to claim 12, wherein at least one output of a secondary-side microcontroller connects the second secondary-side contact of the coupling component to ground.

16. The switched-mode power supply according to claim 12, wherein the switch of the start-up circuit closes when the coupling component is connected to the output voltage and ground via its secondary-side contacts.

17. The switched-mode power supply according to claim 1, wherein the coupling component is formed by an optocoupler or a relay.

18. The switched-mode power supply according to claim 1, wherein the switch controller comprises an N-channel depletion-mode MOSFET.
